(19) United States
(12) Patent Application Publication
(10) Pub. No.: US 2012/0225626 A1
(43) Pub. Date: Sep. 6, 2012

(54) REUSE OF A SWITCH IC AS A STEP ATTENUATOR

(75) Inventors: David White, Indianapolis, IN (US); Alexander Sarapin, Westfield, IN (US)

(73) Assignee: THOMSON LICENSING, Princeton, NJ (US)

(21) Appl. No.: 13/510,211

(22) PCT Filed: Nov. 17, 2009
(86) PCT No.: PCT/US09/06150

§ 371 Date: May 16, 2012

(51) Int. Cl. H04B 1/48

(52) U.S. Cl. 455/79

(57) ABSTRACT

The present invention concerns a system and associated method for providing attenuation of a received signal in a two-way communication circuit without the use of a separate switchable attenuator. Specifically, the attenuation provided by a transmit/receive switch set to the transmit position during reception is used to provide attenuation to a signal reception path.

### BACKGROUND OF THE INVENTION

The present invention generally relates to a system and associated method for providing attenuation of a received signal in a two-way communication circuit without the use of a separate switchable attenuator. Specifically, the attenuation provided by a transmit/receive switch set to the transmit position during reception is used to provide attenuation to a signal reception path.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Television programming is commonly received from satellite or cable sources. Received signals are generally delivered through the home via coaxial cable to a set-top box associated with a television display device. In some environments, multiple set-top boxes are present, each generally connected to a separate display. One or more of the set-top boxes may contain digital video recorder (DVR) capability. A user of one of the set-top boxes may wish to view programming that has been recorded on another set-top box. To facilitate such viewing, various networking schemes, such as the Multimedia over Coax Alliance (MoCA™) standard, have been created to allow one set-box to display content provided by another.

In some cases, the signal received from another set-top device may be stronger than desired for reliable reception. Attenuation of the received signal may therefore be required before the signal is processed by the receiving circuitry. The addition of a switchable attenuator to the set-top box circuitry, however, can add to the cost, complexity, and size of the set-top box. A method is therefore needed to reduce cost by eliminating the need for a switchable attenuator by employing an already existing portion of the circuitry. The invention described herein addresses this and/or other problems.

### SUMMARY OF THE INVENTION

In order to solve the problems described above, the present invention concerns a system and associated method for providing attenuation of a received signal in a two-way communication circuit without the use of a separate switchable attenuator. Specifically, the attenuation provided by a transmit/receive switch set to the transmit position during reception is used to provide attenuation to a signal reception path. This and other aspects of the invention will be described in detail with reference to the accompanying Drawings.

### BRIEF DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is a diagram of an exemplary embodiment of a satellite television system;

FIG. 2 is a block diagram of a satellite television reception system with two-way data communications capability;

FIG. 3 is a block diagram of a portion of the two-way data communications circuitry of the satellite television reception system modified in accordance with the present invention;

The exemplifications set out herein illustrate preferred embodiments of the invention, and such exemplifications are not to be construed as limiting the scope of the invention in any manner.

### DESCRIPTION OF THE PREFERRED EMBODIMENTS

As described herein, the present invention provides a system and associated method for providing attenuation of a received signal in a two-way communication circuit without the use of a separate switchable attenuator. Specifically, the attenuation provided by a transmit/receive switch set to the transmit position during reception is used to provide attenuation to a signal reception path.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The present invention may be implemented in a set-top box or video decoder that is capable of receiving satellite signals, cable television signals, or other transmitted television signals. The signals may comprise encoded packets of data representing video and audio information in compressed form. The signals are encoded such that a video signal can be generated and viewed upon being properly decoded.

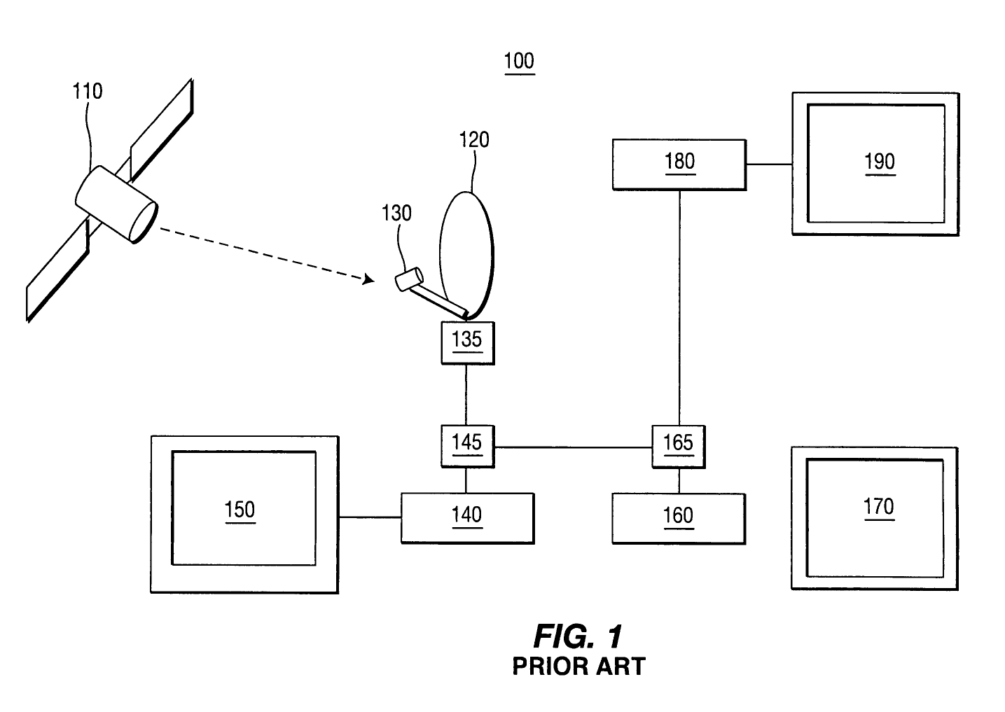

FIG. 1 is a diagram of an exemplary embodiment of a satellite television system. The satellite television system operates to broadcast microwave signals to a wide broadcast area by transmitting the signals from a geosynchronous satellite 110. A geosynchronous satellite 110 orbits the earth once each day at approximately 35,786 kilometers above the surface of the Earth. Such broadcast satellites 110 generally orbit around the equator and remain in the same position with respect to positions on the ground, allowing a satellite receiving antenna 120 to maintain a fixed look angle.

Satellite 110 receives signals from uplink transmitters and then rebroadcasts the signals back to earth using a set of transponders utilizing a variety of transmission frequencies. The altitude of the transmitting satellite 110 allows subscribers in a wide geographical area to receive the signal.

The distance from the earth and the severe power conservation requirements of the satellite result in a relatively weak signal being received at the antenna 120. It is therefore critical that the signal be amplified as soon as possible after it is received by the antenna. This requirement is achieved through the placement of a low noise block downconverter (LNB) 130 at the feed horn of the parabolic dish antenna 120. In a simple single set-top box configuration, the selected signal from the LNB 130 may travel along a coaxial cable to a digital satellite set-top box 140, which tunes a desired channel for presentation on television display device 150.

In more complex installations, a single-wire multi-switch (SWM) 135 may be used to multiplex signals from multiple LNBs and their multiple polarities onto a single coaxial cable for delivery into the home. Splitters 145 and 165 may be used to split the signals to cables running to other set top boxes 160 and 180, connected to television display devices 170 and 190, respectively. A similar configuration may exist in a cable-based installation. A single feed from the local cable distribution system may enter the house and be split to coaxial cables running to multiple cable set-top boxes.

The cabling and splitters used to carry received satellite signals from SWM 135 to set-top boxes 140, 160, and 180, and carry control information back to the SWM 135, may also be used for communication between set-top boxes. For instance, a set-top box 140 containing a DVR may provide access to recorded content to other set-top boxes 160 and 180 in the home. The Multimedia over Coax Alliance (MoCA™) standard describes one method of providing such functionality. In the case of a satellite television system, these digital home networking (DHN) communications between boxes occur at frequencies below those for SWM-to-set-top communications. In the case of cable, DHN communications may occur at frequencies above those of the cable television transmissions. A band-stop filter may be present within or near SWM 135 to prevent interference of DHN communications with satellite signal reception and processing.

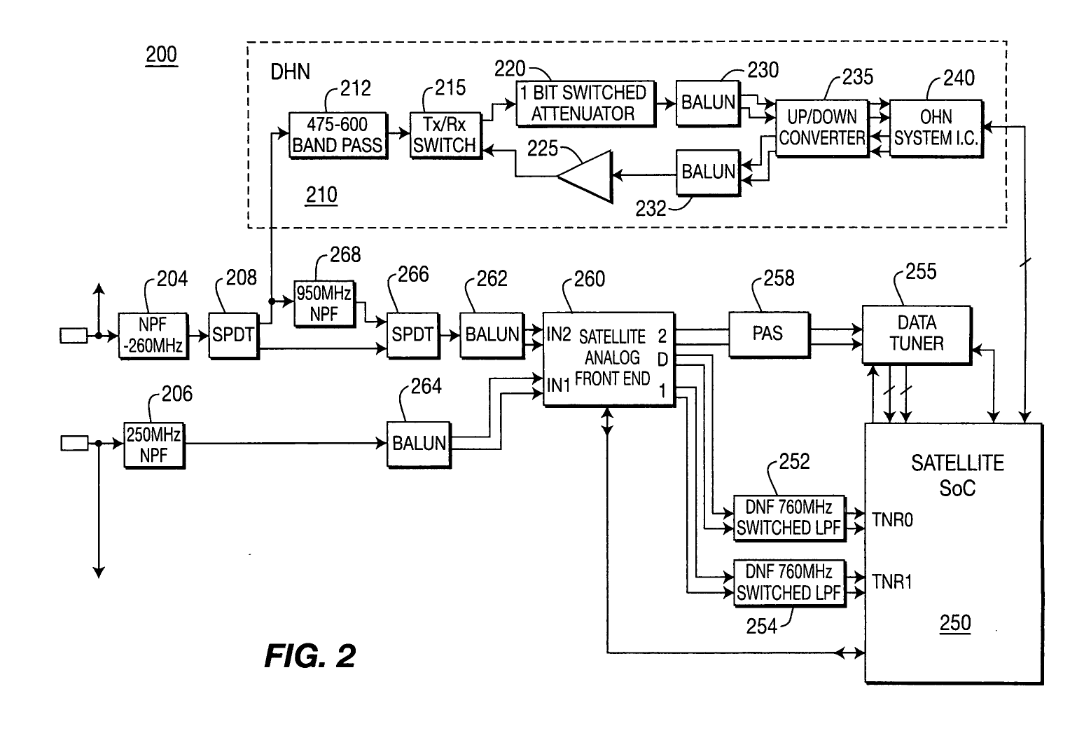

FIG. 2 is a diagram of an example of a satellite television set-top box 200. The signals from the SWM 135 are received at a high pass filter 204. Switches 208 and 266 are used to engage or disengage a DHN data path 210. When engaged, a high pass filter 268 is used to isolate the remainder of the satellite receiver path from the networking signals, which are transmitted at a lower frequency range than the signals from the LNBs. The incoming signal is balanced by balun 262 and passed to the satellite analog front end 260. The satellite analog front end 260 may act as a multiswitch and provide multiple signals from multiple sources to a satellite system-on-a-chip (SoC) 250 and to data tuner 255 for further processing after attenuation or filtering by attenuator 258 and low pass filters 252 and 254.

In this example, the set-top box provides an additional connection for a legacy non-SWM LNB feed. The LNB signal is fed through a high-pass filter 206, balanced by balun 264, and then also processed by the satellite analog front end 260. In most cases, if an SWM is feeding the primary input, this additional LNB connection will not be used.

The satellite SoC is connected via a bus to the DHN data path 210. The DHN path provides two-way communication between set-top box 200 and other set-top boxes or other devices. A band pass filter 212 provides bidirectional filtering and passes the incoming and outgoing data signals. A transmit/receive switch 215 is used to switch the DHN path between transmission and reception modes. Switch 215 is controlled by the DHN firmware and provides a low-loss connection for the selected data path. An amplifier 225 amplifies signals to be transmitted. Baluns 230 and 232 provide conversion from unbalanced to balanced signals, and vice-versa, for received and transmitted signals, respectively. Up/down converter 235 converts signals to an appropriate frequency band for either transmission to another set-top box or processing by the DHN system IC 240.

In the receive path, a switchable attenuator 220 is used to attenuate received data signals when required, for instance, when the signal level is above the linearity limitations of the receiver. An example of such an attenuator is the MaCom AT267. Typical attenuation requirements may be in the range of 15 dB-25 dB, depending on the transmission power of the DHN system, though more or less attenuation may be required.

The switchable attenuator 220 may add cost, complexity, or size to the DHN path and the set-top box. It would therefore be desirable to eliminate the need for the switchable attenuator.

In accordance with the present invention, it is possible to eliminate the switchable attenuator 220 by selectively utilizing the attenuation of the signal provided to the reception path by the TX/RX switch 215 when the switch is set to the transmission position. This may advantageously reduce the complexity, cost, and/or size of the set-top box electronics.

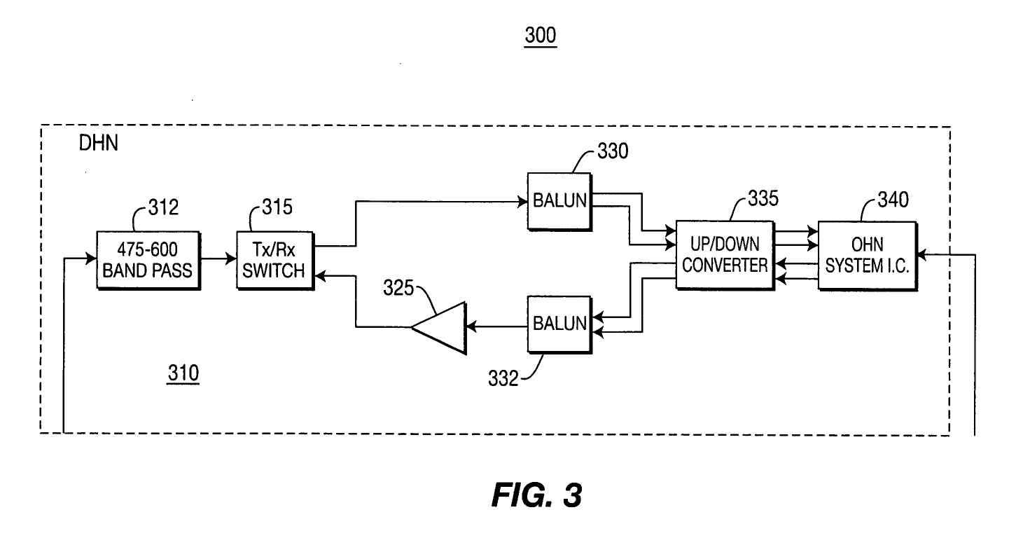

FIG. 3 is diagram of the two-way DHN portion of the set-top box of FIG. 2, modified in accordance with the present invention. A band pass filter 312 provides bidirectional filtering and passes the incoming and outgoing data signals. A transmit/receive switch 315 is used to switch the DHN path between transmission and unattenuated reception modes. Switch 315 is controlled by the DHN firmware and provides a low loss connection for the selected data path. An amplifier 325 amplifies signals to be transmitted. Baluns 330 and 332 provide conversion from unbalanced to balanced signals, and vice-versa, for received and transmitted signals, respectively. Up/down converter 335 converts signals to an appropriate frequency for either transmission to another set-top box or processing by the DHN system IC 340.

A switchable attenuator corresponding to element 220 of FIG. 2 is not present. The attenuation function for reception is provided, when needed, by setting TX/RX switch 315 to the transmission position. The isolation of the switch IC from its common pin to the reception path can then provide the needed attenuation of the received signal. Data transmission would generally be inactive in the attenuated reception mode, despite the switch 315 being set to the transmit position. Switch IC 315 may be selected such that the attenuation characteristics of the switch relative to the reception path, when the switch is in transmission position, are of the desired level.

Thus, the subsystem of FIG. 3 provides at least three operating modes: transmission, attenuated reception, and unattenuated reception. Switch 315 is set to the transmit position for both the transmission and attenuated reception modes, and to the receive position for the unattenuated reception mode. The position of switch 315 for reception may be changed during operation from the normal reception position to the transmission position if high incoming signal strength is detected and attenuation of incoming signals is desired.

While the present invention has been described in terms of a specific embodiment, it will be appreciated that modifications may be made which will fall within the scope of the invention. For example, various processing steps may be implemented separately or combined, and may be implemented in general purpose or dedicated data processing hardware or in software. Furthermore, while the present invention has been described with respect to communication between set-top boxes, the technique of using a switch to provide attenuation to a path which is not selected by that switch may be used in other data communication contexts.

1. A method for data communication comprising the steps of:
coupling first signal processing circuitry to a two-way signal path during a transmission mode of operation;
determining whether a parameter of a signal received via said two-way signal path will be above a threshold; and
coupling second signal processing circuitry to said two-way signal path during a first reception mode of operation responsive to a determination that said parameter of said received signal will not be above said threshold; and
coupling said first signal processing circuitry to said two-way signal path during a second reception mode of operation responsive to a determination that said parameter of said received signal will be above said threshold.

2. The method of claim 1 wherein said coupling second signal processing circuitry to said two-way signal path provides a substantially unattenuated signal from said two-way signal path to said second signal processing circuitry in said first reception mode of operation.

3. The method of claim 1 wherein said coupling said first signal processing circuitry to said two-way signal path provides an attenuated signal from said two-way signal path to said second signal processing circuitry in said second reception mode of operation.

4. The method of claim 3 wherein said signal is attenuated within the range of 10 dB to 30 dB, inclusive.

5. The method of claim 1 wherein said coupling steps are performed using a switch.

6. The method of claim 1 wherein said determining step comprises measuring a parameter of a signal received via said two-way signal path.

7. The method of claim 1 wherein said determining step comprises determining that communications via said two-way signal path comply with a communication standard.

8. A data communication apparatus comprising:
a switch for coupling a two-way signal path to transmission circuitry or reception circuitry; and
a processor for controlling said switch and for determining whether a parameter of a received signal will be above a threshold;
wherein during transmission, said processor causes said switch to couple said two-way signal path to said transmission circuitry;
wherein in a first reception mode of operation, responsive to a determination that said parameter of said received signal will not be above said threshold, said processor causes said switch to couple said two-way signal path to said reception circuitry; and
wherein in a second reception mode of operation, responsive to a determination that said parameter of said received signal will be above said threshold, said processor causes said switch to couple said two-way signal path to said transmission circuitry.

9. The apparatus of claim 8 wherein said switch provides a substantially unattenuated signal from said two-way signal path to said reception circuitry in said first reception mode of operation.

10. The apparatus of claim 8 wherein said switch provides an attenuated signal from said two-way signal path to said reception circuitry in said second reception mode of operation.

11. The apparatus of claim 10 wherein said signal is attenuated within the range of 10 dB to 30 dB, inclusive.

12. The apparatus of claim 8 wherein said determining comprises measuring a parameter of a signal received via said two-way signal path.

13. The apparatus of claim 8 wherein said determining comprises determining that communications via said two-way signal path comply with a communication standard.

14. An apparatus for two-way signal communications comprising:
switching means for coupling a two-way signal path to transmission circuitry means or reception circuitry means; and
processing means for controlling said switching means and for determining whether a parameter of a received signal will be above a threshold;
wherein during transmission, said processing means causes said switching means to couple said two-way signal path to said transmission circuitry means;
wherein in a first reception mode of operation, responsive to a determination that said parameter of said received signal will not be above said threshold, said processing means causes said switching means to couple said two-way signal path to said reception circuitry means; and
wherein in a second reception mode of operation, responsive to a determination that said parameter of said received signal will be above said threshold, said processing means causes said switching means to couple said two-way signal path to said transmission circuitry means.

15. The apparatus of claim 14 wherein said switching means provides a substantially unattenuated signal from said two-way signal path to said reception circuitry means in said first reception mode of operation.

16. The apparatus of claim 14 wherein said switching means provides an attenuated signal from said two-way signal path to said reception circuitry means in said second reception mode of operation.

17. The apparatus of claim 16 wherein said signal is attenuated within the range of 10 dB to 30 dB, inclusive.

18. The apparatus of claim 14 wherein said determining comprises measuring a parameter of a signal received via said two-way signal path.

19. The apparatus of claim 14 wherein said determining comprises determining that communications via said two-way signal path comply with a communication standard.
